(19) United States
(12) Patent Application Publication
(10) Pub. No.: US 2022/0284542 A1
(43) Pub. Date: Sep. 8, 2022

(54) Semantically Altering Medical Images

(71) Applicant: Embryonics LTD, Bet Shemesh (IL)

(72) Inventors: David H. Silver, Haifa (IL); Alex Bronstein, Haifa (IL); Shahar Rosentraub, Atlit (IL); Yael Gold-Zamir, Bet Shemesh (IL); Yotam Wolf, Tel Aviv (IL)

(21) Appl. No.: 17/195,218

(22) Filed: Mar. 8, 2021

(51) Int. Cl. G06T 3/00; G06T 11/60

(52) U.S. Cl. CPC G06T 3/0012; G06T 11/60; G06T 2210/41

(57) ABSTRACT

The present invention extends to methods, systems, and computer program products for semantically altering a medical image. A medical image and a transform are accessed. The transform is used to transform the medical image to a simpler image having reduced complexity relative to the medical image. A semantic alteration is made to content of the simpler image. Another (and possibly inverse) transform is accessed. The other transform is used to transform the simpler image to a more complex image having increased complexity relative to the simpler image (e.g., complexity resembling the medical image). Transforming the simpler image to a more complex image can include propagating the semantic alteration with the increased complexity into content of the more complex image. A medical decision is made in view of the semantic alteration and based on at least a portion of the more complex image content.

### TECHNICAL FIELD

The present disclosure relates generally to medical imaging. Aspects include semantically altering medical images.

### BACKGROUND

Medical imaging includes the technique and process of imaging interior/exterior parts of a body for clinical analysis and medical intervention as well as visual representation of the function of some organs or tissues (physiology). Medical imaging seeks to reveal internal structures hidden by the skin and bones, as well as to diagnose and treat disease. Medical imaging also establishes a database of normal anatomy and physiology to make it possible to identify abnormalities. Medical imaging technologies and techniques include: cameras, X-rays, computed tomography (CT) and computerized axial tomography (CAT), positron-emission tomography (PET), Magnetic resonance imaging (MRI), Ultrasound, fluoroscopy, and Bone densitometry (DEXA or DXA).

Captured medical images can be viewed in real-time at a display device and/or moved to storage media for later viewing.

Within a captured medical image (and possibly dependent on a medical condition under review), some (more relevant) portions of the medical image can have increased diagnostic value while other (less relevant) portions of the medical image can have reduced diagnostic value. For example, a portion of a medical image can clearly reveal a broken bone. Other portions of the medical image can include irrelevant background or imaging artifacts.

It is also possible that less relevant portions of a medical image obscure more relevant portions of the medical image. For example, an image artifact may obscure part of an organ that has been imaged to check for possible disease. As such, in addition to having reduced diagnostic value, these less relevant portions can also hinder an accurate medical diagnosis.

Further, some medical images can include patient specific information having reduced diagnostic value. For example, a dental X-ray of a tooth can depict a cavity or other tooth problem and can also depict tooth characteristics unique to a patient.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device

FIG. 2 illustrates an example computer architecture that facilitates semantically altering a medical image.

FIG. 3 illustrates a flow chart of an example method for semantically altering a medical image.

### DETAILED DESCRIPTION

The present invention extends to methods, systems, and computer program products for semantically altering a medical image. A medical image and a transform can be accessed. The transform can be used to transform the medical image to a simpler image having reduced complexity relative to the medical image. A semantic alteration can be made to content of the simpler image.

Another (and possibly inverse) transform can be accessed. The other transform can be used to transform the simpler image to a more complex image having increased complexity relative to the simpler image. Transforming the simpler image to a more complex image can include propagating the semantic alteration with the increased complexity into content of the more complex image. A medical decision can be made in view of the semantic alteration and based on at least a portion of the more complex image content.

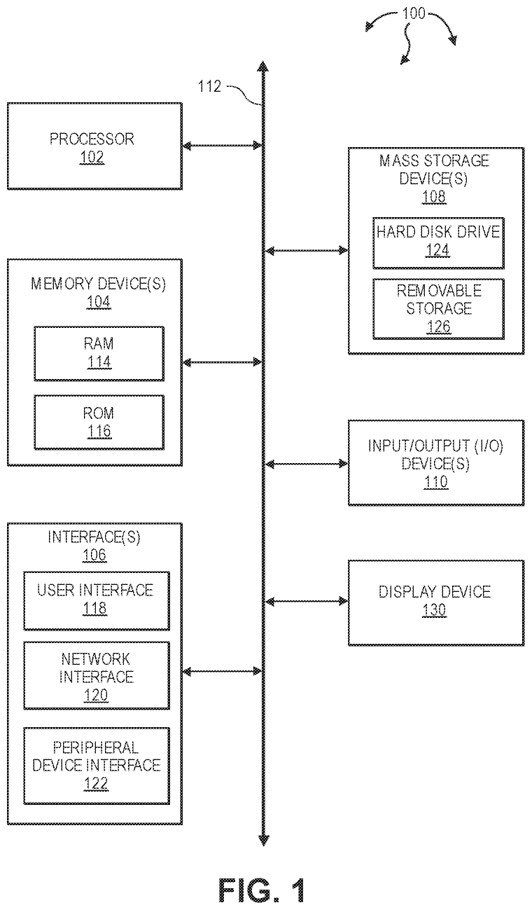

Turning to FIG. 1, FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices or cloud and DevOps tools, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory. Processor(s) 102 can be real or virtual and can be allocated from on-premise, cloud computing or any cloud provider.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory. Memory device(s) 104 can be real or virtual and can be allocated from on-premise, cloud computing or any cloud provider.

Mass storage device(s) 108 include various computer storage media, such as magnetic tapes, magnetic disks, optical disks, solid state memory/drives (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media. Mass storage device(s) 108 can be real or virtual and can be allocated from on-premise, cloud computing or any cloud provider.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, medical imaging devices, lenses, radars, CCDs or other image capture devices (including devices and systems used to capture medical images), and the like. I/O device(s) 110 can be real or virtual and can be allocated from on-premise, cloud computing or any cloud provider.

Display device 130 includes any type of device capable of displaying information to one or more users of computing device 100. Examples of display device 130 include a monitor, display terminal, video projection device, and the like. Display device 130 can be real or virtual and can be allocated from on-premise, cloud computing or any cloud provider.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Network interface 120 can connect computing device 100 to other devices and systems, including devices and systems configured to capture, store, transfer, and process medical images. Other interfaces include user interface 118 and peripheral device interface 122. Interface(s) 106 can be real or virtual and can be allocated from on-premise, cloud computing or any cloud provider. Peripheral device interface 122 can connect computing device 100 to other devices and systems, including devices and systems configured to capture, store, transfer, and process medical images.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth. Bus 112 can be real or virtual and can be allocated from on-premise, cloud computing or any cloud provider. Any of a variety of protocols can be implemented over bus 112, including protocols used to capture, store, transfer, and process medical images.

In this description and the following claims, “image content” is defined as a grouping of one or more graphical elements within an image. Graphical elements can be or include pixels, voxels, texels, etc. Image content (e.g., objects or properties) can include digitally defined image content and/or semantically defined image content. Image content can be represented in two dimensions or three dimensions.

In this description and the following claims, “digitally defined” image content is defined as image content that includes a lower level of (or no) abstraction, such as, for example, color, intensity, geometric shape, etc.

In this description and the following claims “digital alteration” is defined as changing digitally defined image content.

In this description and the following claims, “semantically defined” image content is defined as image content that includes a higher level of abstraction. Semantically defined image content can include, for example, a disease, a condition, a diagnosis, an organ, a cell, a cell grouping, a bone, a tooth, a tumor, a cyst, a blood vessel, living tissue, disease impact, an embryo, etc. or portions thereof. In some aspects, a plurality (or grouping) of digitally defined graphical elements is utilized to represent semantically defined image content. For example, a disease impact can be represented by color, intensity, geometric shape, etc., of a plurality of pixels.

In this description and the following claims, “sematic alteration” is defined as changing semantically defined image content. Changing semantically defined image can include any of: emphasizing, de-emphasizing, deleting, augmenting, annotating, indicating differences between, etc. the semantically defined objects or properties. In some aspects, semantic alteration of semantically defined image content inherently includes digital alteration of corresponding digitally defined image content. For example, emphasizing a tumor in image content can inherently change color, intensity, etc. of a pixel grouping depicting the tumor in the image content.

In general, a “simpler” image has reduced complexity relative to a medical image or a more complex image (e.g., that resembles a medical image). Transformation from a medical image to a simpler image can include retaining sufficient (and possibly specifically selected) image content that is more relevant to a medical decision and reducing or eliminating other image content that is less relevant to the medical decision. Transforming a medical image to a simpler image can include digitally altering the medical image. However, transforming a medical image to a simpler image can include limited, if any, semantic alteration. Thus, semantically defined image content in a medical image can be sufficiently propagated into a simpler image during transformation.

For example, a medical image of cell can include cell shape and texture. A corresponding simpler image of the cell can include just cell shape. An Mill image of a brain can indicate neurons or cell types at different grey levels. A corresponding simpler image can indicate neurons or cell types as assigned flat colors. In an ultrasound image of a fetus, bones can be white but hazy relative to other tissues. A corresponding simpler image can resemble a textbook drawing of the fetus. For example, the simpler image can use simplified colors for bone and other tissues without ultrasound artifacts or less relevant (and potentially unnecessary) details.

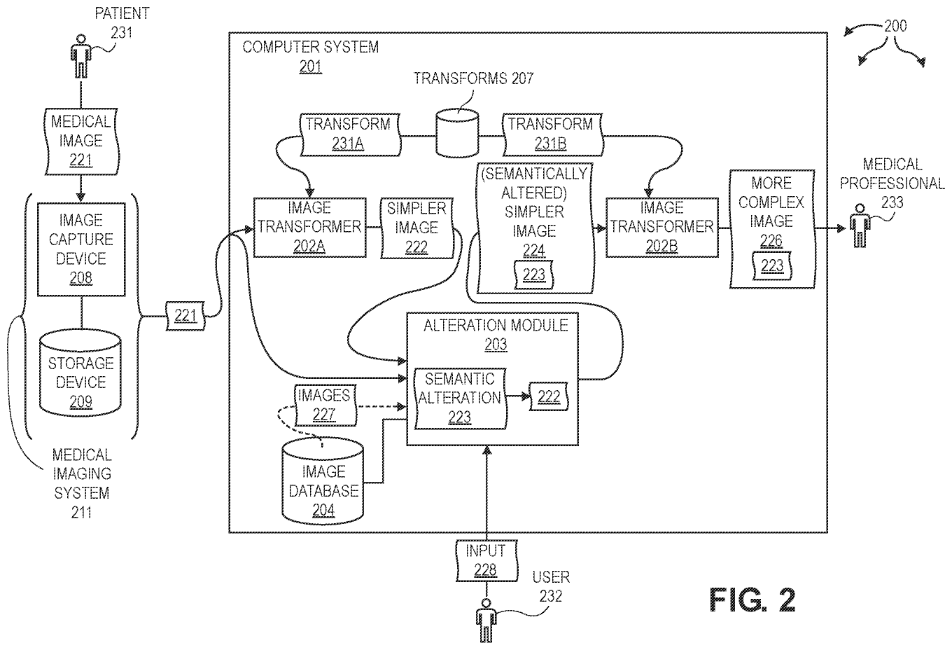

FIG. 2 illustrates an example computer architecture 200 that facilitates semantically altering a medical image. As depicted, computer architecture 200 includes computer system 201 and medical imaging system 211.

Medical imaging system 211 further includes image capture device 208 and storage device 209. In general, image capture device 208 can capture a medical image of a patient. Captured images can be stored at storage device 209 and/or transferred to other computer systems (e.g., computer system 101). Various medical imaging technologies and techniques can be used to capture a two-dimensional medical images or three-dimensional medical images, including capturing internal and/or external anatomical features, morphological features, kinetic features, etc. Medical image capture can be implemented using image technologies and techniques including: cameras (brightfield, darkfield, phase-contrast, etc.), X-rays, computed tomography (CT) and computerized axial tomography (CAT), positron-emission tomography (PET), Magnetic resonance imaging (MRI), Ultrasound, fluoroscopy, and Bone densitometry (DEXA or DXA), etc. As such, medical image system 211 can include components configured to capture medical images including any of: a camera image, an X-ray image, a computer tomography (CT) image, a computerized axial tomography (CAT) image, a positron-emission tomography (PET) image, a Magnetic resonance imaging (MRI) image, an Ultrasound image, a fluoroscopy image, a Bone densitometry (DEXA or DXA) image, etc.

Computer system 201 further includes image transformers 202A and 202B, alteration module 203, image database 204, and transforms 207. Image transformers 202A and 202B are executable modules configured to transform images in accordance with received transforms (e.g., transforms accessed from transforms 207). In one aspect, image transformers 202A and 202B are included in the same component or module.

Transforms 207 can include: (1) transforms configured to transform medical images into simpler images and (2) transforms configured to transform simpler images into more complex images. In one aspect, transforms configured to transform simpler images to more complex images are more specifically configured to transform simpler images back to images at least resembling (and potentially actually being) medical images. A transform configured to transform a simpler image to more complex images may also be an inverse transform of a transform configured to transform a medical image to a simpler image.

An inverse transform can transform an image essentially back to its original form. For example, a transform can be used to transform a medical image format to a simpler image format. The corresponding inverse transform can be used to transform the simpler image format back to medical image format.

Transforms can be tailored to one or more of: medical image type (X-ray, PET scan, ultrasound, etc.), diagnostic purpose of a medical image (e.g., X-ray for possible broken bone, microscopic image of embryo for viability, CT scan from tumor size/shape, etc.), patient characteristics (e.g., age, gender, etc.), image dimensions (e.g., two-dimensional or three-dimensional), other transforms used in prior transformations, etc.

For example, a transform and another (e.g., inverse) transform can be tailored to one another. The transform can be used to transform a medical image to a simpler image. Subsequently, the other (e.g., inverse) transform can be used to transform the simpler image to a more complex image (e.g., resembling the medical image).

Alteration module 203 can make semantic alterations to image content. Alteration module 203 can implement manually input semantic alterations to image content. Alteration module 203 can also automatically derive semantic alterations and implement automatically derived semantic alterations to image content.

Semantic alterations can include obscuring image content (e.g., patient identifiable information/content), removing image content (e.g., background or artifacts), etc. Obscuring image content can include blurring out the image content or otherwise rending the image content unrecognizable (e.g., so that a patient is no longer identifiable from the image content). Semantic alterations, including obscuring or removing image content, can be implemented in a manner that minimizes any impact on the overall medical diagnostic relevance of an image.

Alteration module 203 can also make semantic augmentations to image content. Semantic alterations to an image include semantic augmentations to an image. Semantic augmentations can include emphasizing image content, de-emphasizing image content, annotating image content, etc. In one aspect, image content having at least a threshold diagnostic relevance to a medical decision can be emphasized. In another aspect, image content having less than a threshold diagnostic relevant to a medical decision can be de-emphasized. Annotating an image can include adding a textual description associated with image content to the image. Semantic augmentations, including emphasizing, de-emphasizing, and annotating image content, can be implemented in a manner that minimizes any impact on the overall medical diagnostic relevance of an image (and may increase the overall medical diagnostic relevance).

Image database 204 can store medical images from one or more patients. Semantic augmentations can also include indicating (e.g., anatomical (internal and/or external), morphological, kinetic, etc.) differences between a patient and one or other patients, etc. Alteration module 103 can detect patient differences by comparing a patient medical image to medical images of one or more other patients (e.g., accessed from image database 204). Alteration module 103 can indicate detected differences through emphasizing and/or annotating image content.

Simpler images may be more efficiently and/or effectively semantically altered and/or augmented relative to medical images. As such, in some aspects, semantic alterations and/or semantic augmentations are implemented in a simpler image. The semantic alterations and/or semantic augmentations are then subsequently propagated to a corresponding more complex image (e.g., resembling a medical image) during transformation.

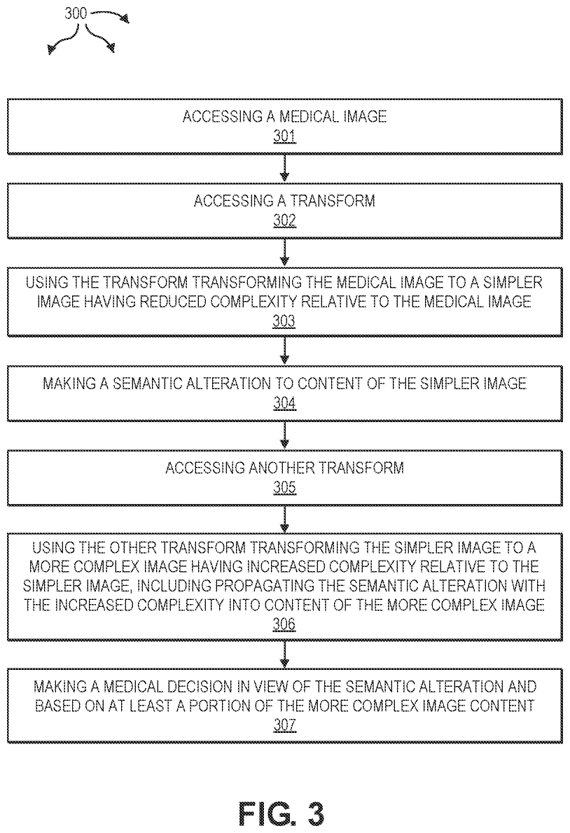

FIG. 3 illustrates a flow chart of an example method for 300 semantically altering a medical image. Method 300 will be described with respect to the components and data of computer architecture 200.

Image capture device 208 can capture medical image 221 of patient 231. Image capture device 208 can store medical image 221 at storage device 209 and/or can send image 221 to computer system 201.

In one aspect, medical image 221 is one of a series of time lapse microscopic images of developing embryos.

Method 300 includes accessing a medical image (301). For example, computer system 201 can access medical image 221 (e.g., a 2D or 3D medical image) from medical imaging system 211. Medical image 221 can be transferred to and/or accessed by image transformer 202A as well as alteration module 203.

Method 300 includes accessing a transform (302). For example, image transformer 202A can access transform 231A from transforms 207. Image transformer 202A can access transform 231A based on one or more of: image type of medical image 221 (e.g., camera image, X-ray image, CT scan image, etc.), the diagnostic purpose associated with medical image 221, dimensionality of medical image 221 (e.g., is medical image 221 a 2D or 3D image), characteristics of patient 231, etc.

Method 300 includes using the transform transforming the medical image to a simpler image having reduced complexity relative to the medical image (303). For example, image transformer 202A can use transform 231A to transform medical image 221 to simpler image 222. In one aspect, using transform 231A digitally alters image content in medical image 221 to derive simpler image 222. However, using transform 231A incudes limited, if any, sematic alteration to image content in medical image 221. Thus, semantically defined image content in medical image 221 is sufficiently propagated into and/or is sufficiently represented in simpler image 222 after transformation.

Method 300 includes making a making a semantic alteration to content of the simpler image (304). For example, alteration module 203 can make semantic alteration 223 to simpler image 222. In one aspect, alternation module 203 makes semantic alteration 223 to image 222 in response to input 228 from user 232 (e.g., entered through a user-interface to alteration module 203). User 232 can be a medical technician or other medical professional. For example, user 232 can be associated with a radiology consultation on image content in medical image 221. User 232 can observe phenomena of interest in the image content and semantically alter (e.g., highlight) the phenomena of interest.

In another aspect, alteration module 203 automatically derives semantic alteration 223 and makes semantic alteration 223 to simpler image 222.

Sematic alteration 223 may include obscuring or removing image content from simpler image 222. In one aspect, alteration module 203 obscures image content in simpler image 222 that can potentially be used to identify patient 231. In another aspect, alteration module 203 removes medically irrelevant background or medically irrelevant image artifices from simpler image 222.

Semantic alteration 223 may also include emphasizing image content in simpler image 222, de-emphasizing image content in simpler image 222, or annotating image content in simpler image 222.

In one aspect, alteration module 203 accesses medical images 227 from image database 204. Alteration module 203 can compare medical image 221 to medical images 227. Alteration module 203 can detect one or more of: an (internal and/or external) anatomical, a morphological, or a kinetic difference between medical image 221 and medical images 227. Alteration module 103 can indicate detected differences between medical image 221 and medical images 227 by emphasizing image content and/or annotating image content in medical image 221. Differences in a medical image can in turn indicate corresponding differences between patient 231 and one or more other patients.

Making semantic alteration 223 to image 222 (either automatically or manually) can form (semantically altered) simpler image 224 that includes semantic alteration 223. Alteration module 203 can send simpler image 224, including semantic alteration 223, to image transformer 202B. Image transformer 202B can receive simpler image 224 from alteration module 203.

Method 300 includes accessing another transform (305). For example, image transformer 202B can access transform 231B. In one aspect, transform 231B is an inverse transform of transform 231A. Image transformer 202B can access transform 231B based on one or more of: image type of medical image 221 (e.g., camera image, X-ray image, CT scan image, etc.), the diagnostic purpose associated with medical image 221, dimensionality of medical image 221 (e.g., is medical image 221 a 2D or 3D image), characteristics of patient 231, prior use of transform 231A, etc.

Method 300 includes using the other transform transforming the simpler image to a more complex image having increased complexity relative to the simpler image, including propagating the semantic alteration with the increased complexity into content of the more complex image (306). For example, image transformer 202B can use transform 231B to transform simpler image 224 to more complex image 226. More complex image 226 can have increased complexity relative to simpler image 222 and/or can have complexity approximating that of medical image 221. Transforming simpler image 224 to more complex image 226 can include propagating semantic alteration 223 into image content of more complex image 226. Propagating semantic alteration 223 can include representing semantic alteration 223 at the increased complexity and/or representing semantic alteration 223 at the complexity approximating that of medical image 221 within more complex image 226.

More complex image 226 can be sent to medical professional 233. In one aspect, medical professional 233 views more complex image 226 through a user interface to computer system 201. In another aspect, more complex image 226 is sent in an electronic message (e.g., email) to medical professional 233.

Method 300 includes making a medical decision in view of the semantic alteration and based on at least a portion of the more complex image content (307). For example, medical professional 233 can make a medical decision with respect to patient 231 in view of semantic alteration 223 and based on at least a portion of image content in more complex image 226. In one aspect, medical professional 233 is a physician that relies on semantic alteration 223 in making a medical decision with respect to patient 231. The medical decision can relate to diagnosis, treatment, a procedure, etc. associated with patient 231.

Accordingly, aspects of the invention facilitate alteration of simpler images where relevant medical conditions may be more readily observed. The alterations can then be propagated back to more complex images resembling original medical images.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (SSDs) (e.g., RAM-based or Flash-based), Shingled Magnetic Recording (SMR) devices, storage class memory (SCM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: medical images, other images, transforms, simpler images, semantic alterations, semantic augmentations, more complex images, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, medical images, other images, transforms, simpler images, semantic alterations, semantic augmentations, more complex images, etc.

Implementations of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, imaging devices, medical imaging systems, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as on premise, private cloud, community cloud, public cloud, hybrid cloud, and so forth. In this description and in the following claims, a “cloud computing environment” is an environment in which cloud computing is employed.

Hybrid cloud deployment models combine portions of other different deployment models, such as, for example, a combination of on premise and public, a combination of private and public, a combination of two different public cloud deployment models, etc. Thus, resources utilized in a hybrid cloud can span different locations, including on premise, private clouds, (e.g., multiple different) public clouds, etc.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
accessing a medical image;
accessing a transform;
using the transform transforming the medical image to a simpler image having reduced complexity relative to the medical image;
making a semantic alteration to content of the simpler image;
accessing another transform;
using the other transform transforming the simpler image to a more complex image having increased complexity relative to the simpler image, including propagating the semantic alteration with the increased complexity into content of the more complex image; and
making a medical decision in view of the semantic alteration and based on at least a portion of the more complex image content.

2. The method of claim 1, wherein semantically altering the simpler image comprises semantically augmenting the simpler image.

3. The method of claim 2, wherein semantically augmenting the simpler image comprises:
identifying a graphical element in the simpler image having at least a threshold diagnostic relevance to the medical decision; and
emphasizing the graphical element in the simpler image forming an emphasized graphical element; and
wherein using the other transform transforming the simpler image comprises propagating emphasis of the graphical element within the more complex image content.

4. The method of claim 2, wherein semantically augmenting the simpler image comprises:
identifying a graphical element in the simpler image having less than a threshold diagnostic relevance to the medical decision; and
de-emphasizing the graphical element in the simpler image forming a de-emphasized graphical element; and
wherein using the other transform transforming the simpler image comprises propagating de-emphasis of the graphical element within the more complex image content.

5. The method of claim 2, wherein semantically augmenting the simpler image comprises adding an annotation to a graphical element in the simpler image; and
wherein using the other transform transforming the simpler image comprises propagating within the more complex image content.

6. The method of claim 2, wherein accessing a medical image comprises accessing a medical image associated with a patient;
wherein semantically altering the simpler image comprises:
identifying one or more of: an anatomical difference, a morphological difference, or a kinetic difference between the patient and one or more other patients within the content of the simpler image; and
indicating the one or more of: the anatomical difference, the morphological difference, or the kinetic difference in the simpler image; and
wherein using the other transform transforming the simpler image comprises propagating the indication of the one or more of: the anatomical difference, the morphological difference, or the kinetic difference within the more complex image

7. The method of claim 1, wherein accessing a medical image comprises accessing a medical image associated with a patient;
wherein semantically altering the simpler image comprises:
locating patient identifiable content within the simpler image; and
obscuring the patient identifiable content within the simpler image; and
wherein using the other transform transforming the simpler image comprises propagating obscuring the patient identifiable content within the more complex image.

8. The method of claim 1, wherein semantically altering the simpler image comprises removing content from the simpler image; and
wherein using the other transform transforming the simpler image comprises transforming the simpler image to the more complex image without considering the removed content.

9. The method of claim 8, wherein removing content from the simpler image comprises:
identifying one of: irrelevant background in the simpler image or an image artifact in the simpler image; and
removing the one of: the irrelevant background or the image artifact from the simpler image.

10. The method of claim 1, wherein accessing a medical image comprises accessing one of: a camera image, an X-ray image, a computer tomography (CT) image, a computerized axial tomography (CAT) image, a positron-emission tomography (PET) image, a Magnetic resonance imaging (MRI) image, an Ultrasound image, a fluoroscopy image, and Bone densitometry (DEXA or DXA) image.

11. The method of claim 1, wherein accessing a medical image comprises accessing a three-dimensional medical image;
wherein using the transform transforming the medical image to a simpler image comprises using the transform transforming the three-dimensional medical image to a simpler three-dimensional image; and
wherein using the other transform transforming the simpler image to a more complex image comprises using the other transform transforming the simpler three-dimensional image to a more complex three-dimensional image.

12. The method of claim 1, wherein accessing the other transform comprises accessing an inverse transform of the transform; and
wherein using the other transform transforming the simpler image to a more complex image comprises using the inverse transform transforming the simpler image to the more complex image.

13. A system comprising:
a processor; and
system memory coupled to the processor and storing instructions configured to cause the processor to:
access a medical image;
access a transform;
use the transform transforming the medical image to a simpler image having reduced complexity relative to the medical image;
make a semantic alteration to content of the simpler image;
access another transform;
use the other transform transforming the simpler image to a more complex image having increased complexity relative to the simpler image, including propagating the semantic alteration with the increased complexity into content of the more complex image; and
make a medical decision in view of the semantic alteration and based on at least a portion of the more complex image content.

14. The system of claim 1, wherein instructions configured to semantically alter the simpler image comprise instructions configured to semantically augment the simpler image.

15. The system of claim 14, wherein instructions configured to semantically augment the simpler image comprise instructions configured to:
identify a graphical element in the simpler image having at least a threshold diagnostic relevance to the medical decision; and
emphasize the graphical element in the simpler image forming an emphasized graphical element; and
wherein instructions configured to use the other transform transforming the simpler image comprise instructions configured to semantically augment to propagate emphasis of the graphical element within the more complex image content.

16. The system of claim 14, wherein instructions configured to semantically augment the simpler image comprise instructions configured to:
identify a graphical element in the simpler image having less than a threshold diagnostic relevance to the medical decision; and
de-emphasize the graphical element in the simpler image forming a de-emphasized graphical element; and
wherein instructions configured to use the other transform transforming the simpler image comprise instructions configured to propagate de-emphasis of the graphical element within the more complex image content.

17. The system of claim 13, wherein instructions configured to accessing a medical image comprises instructions configured to access a medical image associated with a patient;
wherein instructions configured to semantically altering the simpler image comprise instructions configured to:
locate patient identifiable content within the simpler image; and
obscure the patient identifiable content within the simpler image; and
wherein instructions configured to use the other transform transforming the simpler image comprise instructions configured to propagating obscuring the patient identifiable content within the more complex image.

18. The system of claim 13, wherein instructions configured to access a medical image comprise instructions configured to access one of: a camera image, an X-ray image, a computer tomography (CT) image, a computerized axial tomography (CAT) image, a positron-emission tomography (PET) image, a Magnetic resonance imaging (MRI) image, an Ultrasound image, a fluoroscopy image, and Bone densitometry (DEXA or DXA) image.

19. The system of claim 13, wherein instructions configured to access a medical image comprise instructions configured to accessing a three-dimensional medical image;
wherein instructions configured to use the transform transforming the medical image to a simpler image comprise instructions configured to use the transform transforming the three-dimensional medical image to a simpler three-dimensional image; and
wherein instructions configured to use the other transform transforming the simpler image to a more complex image comprise instructions configured to use the other transform transforming the simpler three-dimensional image to a more complex three-dimensional image.

20. The system of claim 13, wherein instructions configured to access the other transform comprise instructions configured to access an inverse transform of the transform; and
wherein instructions configured to use the other transform transforming the simpler image to a more complex image comprise instructions configured to use the inverse transform transforming the simpler image to the more complex image.
